(19) United States
(12) Patent Application Publication
(10) Pub. No.: US 2011/0103383 A1
(43) Pub. Date: May 5, 2011

(54) TWO DIMENSIONAL LOCATION TRANSPARENCY OF SOFTWARE SERVICES

(75) Inventors: Dave Miller, Minneapolis, MN (US); Randy R. Magnuson, Scottsdale, AZ (US); Bradley John Barton, Albuquerque, NM (US); Qingqiu Ginger Shao, Oro Valley, AZ (US)

(73) Assignee: HONEYWELL INTERNATIONAL INC., Morristown, NJ (US)

(21) Appl. No.: 12/609,882

(22) Filed: Oct. 30, 2009

(51) Int. Cl. H04L 12/56

(52) U.S. Cl. 370/392

(57) ABSTRACT

Provided are methods and systems distributing a data message to an unknown destination device across at least one spatial boundary and at least one administrative domain boundary from an originating device. The system includes at least one distributor module that exists within each administrative domain of a network through which the data message may originate, may terminate or may traverses in route from the originating device to the unknown destination device. Each administrative domain within each of a plurality of equipment platforms has at least one distributor module. The system also includes a domain bridge spanning the at least one administrative domain boundary within an equipment platform of the plurality through which the data message traverses in route to the unknown destination device. The system operates using a network discovery service whereby an advertisement is published for a specific type of data by the unknown destination device. The advertisement is promulgated throughout the network. Each distributor module in the network acts a surrogate for the unknown destination device by accepting the data and relaying it to another surrogate until it arrives at the destination device. The system allows the data to pass through both spatial and administrative barriers automatically.

### STATEMENT REGARDING FEDERALLY SPONSORED RESEARCH OR DEVELOPMENT

This invention was made with Government support under contract W56 HZV-05-C-0724 that was awarded by the United States Army. The Government has certain rights in this invention.

### TECHNICAL FIELD

The subject matter described herein relates to computer network communications. More specifically, the subject matter described herein relates to a unified mechanism configured to facilitate computer network communications such that software services may be located across spatial domain boundaries as well as across administrative domain boundaries, nearly simultaneously.

### BACKGROUND

The world today is dependent on the use of internetworks to receive and disseminate information around the globe to those that need or want the information. The conventional means for directing this information between communicants is via of an internet protocol (“IP”) that defines the rules for packaging intranetwork and internetwork data traffic into IP datagrams. The IP further defines the rules for moving these IP datagrams across spatial boundaries utilizing an IP address for delivery. Each network that is connected to an internetwork (e.g. the “Internet”) is identified by a unique IP address or a block of IP addresses.

To communicate a datagram between networks that are either logically or physically separated on a network, a source computing device compiles a structured datagram that is addressed to a specific destination host computing device. The source computing device and the destination computing device each has its own unique IP address so that they may be found on the internetwork in order to receive the datagram and to identify the sender. In other words, a known destination address is necessary for a data transmission to occur.

After compiling the datagram, the source host encapsulates the IP datagram into a network frame and sends the network frame to a local default router, which then opens up the frame and reads the IP datagram. The router reads the diagram's destination IP address to determine if the destination address resides within its own local network or elsewhere. If the destination IP address is located elsewhere, the default router re-encapsulates the datagram and forwards it to another router in another network associated with the destination IP address based on a list of destination addresses listed in a routing table. In a repetitive fashion, the datagram is then forwarded (i.e. hopped) from one network router to another based on each successive router's routing table until the destination address is ultimately reached. It is therefore a fundamental operating principle in network communications that a datagram destination is known, although the exact path through the network may or may not be known.

A datagram destination is usually located by referring to a routing table. A routing table is a list of IP addresses that identifies each destination host computing device and each router that is known to a network computing device. There are several types of routing tables in use within an internetwork. However, a common feature of each is that they operate by looking up a destination IP address from a list of known IP addresses. The routing table provides a router with the IP address of the next best destination to which the datagram is to be sent. Therefore, if a computing node on the network is physically or electronically altered, routing tables listing that node are no longer correct and must be recompiled to reflect the change in the network topology. Routing tables may be updated using methods known in the art, such as polling next hop nodes for information or broadcasting a request for all computing nodes that are listening in the internetwork to provide their IP addresses, etc.

The destination host computing device receives IP datagrams by “listening” on the network for those datagrams addressed to it or addressed to a device residing in its local network. In some local networks, this host computing device is known as a gateway or a gateway server. When a recognized datagram is received, it is de-multiplexed and executed, or forwarded. Typically, the destination host computing device is, or incorporates, a fire wall or some other type of security hardware or software barrier to prevent unauthorized or malicious access to the local network beyond the firewall.

When being communicated to a remote gateway over the network, an IP datagram may encounter several different layers of security that deny access to higher administrative domains that may be located behind the gateway. A password, pass code, hash or some other type of security key is needed by the datagram to proceed up the chain of authorization to either deliver or to access information at the higher security/authorization domain.

A common example of a remote multi-domain environment may be the website of a bank. Being a business, anybody may access the unguarded home page of the bank's website, which may contain advertisements, contact telephone numbers, and other information of a public nature. However, to access a specific account, a security boundary must be passed that usually requires a special dataset be presented. To proceed even further into the bank's network or to access other functions, additional security boundaries must be passed using other access means. These security boundaries may be traversed by negotiating with a “cross domain guard” (“CDG”) or other type of firewall. However, unless one knows that the upper security levels exist and how to reach them, applications and data residing there remain hidden from a user or from access by a datagram.

Therefore, in instances where a multi-layer security domains exist within a specific network, a datagram must first be communicated across a spatial domain barrier to a known IP address and then work its way up through a number of administrative domain barriers until the correct destination domain may be communicated with (i.e. receive data or provide data). Further, multiple iterations of data communications may be required to accomplish both a spatial and an administrative domain traversal. As such, there is a need for methods and systems to communicate automatically with computing entities across both spatial and administrative boundaries automatically and substantially simultaneously.

### BRIEF SUMMARY

It should be appreciated that this Summary is provided to introduce a selection of non-limiting concepts. The embodiments disclosed herein are exemplary as the combinations and permutations of various features of the subject matter disclosed herein are voluminous. The discussion herein is limited for the sake of clarity and brevity.

A system is provided for distributing a data message to an unknown destination device across at least one spatial boundary and at least one administrative domain boundary from an originating device. The system includes one distributor module of a plurality of distributor modules that is resident within each administrative domain through which the data message originates, terminates and traverses in route from the originating device to the unknown destination device, wherein there is at least one administrative domain within each of a plurality of equipment platforms. The system also includes a domain bridge spanning the at least one administrative domain boundary within an equipment platform of the plurality through which the data message traverses in route to the unknown destination device. A means is also provided for discovering an advertisement for the data message that is published by a distributor module that is spatially distant from the administrative domain in which the data message exists.

A method is provided for distributing a data message from an originating computing device to an unknown destination device across at least one spatial boundary and at least one administrative domain boundary. The method includes the steps of receiving a data message from the originating computing device and discovering an advertisement published in a local area network (LAN) directory advertising that a device is a local processor for the data message. If a LAN advertisement is found in the LAN directory, then delivering the data message to the local processor. If an LAN advertisement is not found in the LAN directory, then discovering an advertisement published in a wide area network (WAN) directory advertising that a remote device is a surrogate distributor module for the data message from the originating computing device and then delivering the message to the advertising surrogate distributor module.

A computer readable storage medium is provided for that contains instructions that when executed perform various functions. Those functions include receive a data message from the originating computing device and discover an advertisement published in a LAN directory advertising that a device is a local processor for the data message from the originating computing device. If the advertisement published in the LAN directory is found, then deliver the data message to the local processor. If the advertisement published in a LAN directory is not found, then discover an advertisement published in a WAN directory that a remote device is a surrogate distributor module for the data message from the originating computing device and then deliver the message to the advertising distributor module.

### BRIEF DESCRIPTION OF THE DRAWINGS

FIG. 1 is a simplified exemplary functional flow diagram depicting the initialization of distributors to handle data routing for processing.

FIG. 2 is a simplified exemplary functional flow diagram depicting the communication path of a datagram across multiple spatial and administrative boundaries.

FIG. 3 is a simplified exemplary functional flow diagram depicting the communication paths of datagrams to a destination application module.

FIG. 4 is a simplified exemplary functional flow diagram illustrating the promulgation of an advertisement.

FIG. 5 is a simplified exemplary functional flow diagram illustrating the promulgation of an advertisement.

FIG. 6 is a simplified exemplary functional flow diagram illustrating the transmission of data through a network.

### DETAILED DESCRIPTION

The following disclosure is directed to systems and methods that provide a means to automatically deliver data to an unknown software service (i.e. an application module) that may be remote from a transmitting computing device both spatially and administratively. The systems and methods herein also allow for a dynamic network topology reconfiguration without having to regenerate or reconfigure routing tables.

The subject matter now will be described more fully below with reference to the attached drawings which are illustrative of various exemplary embodiments disclosed herein. Like numbers refer to like objects throughout the following disclosure. The attached drawings have been simplified to clarify the understanding of the systems, devices and methods disclosed. The subject matter may be embodied in a variety of forms. The exemplary configurations and descriptions, infra, are provided to more fully convey the subject matter disclosed herein.

The subject matter herein will be generally disclosed in the context of a network that links a number of equipment platforms. Non-limiting examples of equipment platforms in which the subject matter herein below may be applied includes hand held communication devices, industrial facilities, aircraft, spacecraft, watercraft and terrestrial motorized vehicles. Without limitation, terrestrial motor vehicles may also include military combat and support vehicles of any description. It will be appreciated by those of ordinary skill in the art after reading the disclosure herein below that the subject matter contained therein is similarly applicable to a plethora of other equipment platforms, equipment types, networks and internetworks.

Each equipment platform includes one or more computing devices wherein the computing devices populate one or more distinct administrative domains within each platform. The administrative domains maybe separated logically within a common hardware device, but may also comprise segregated hardware, firmware and/or software as may be found useful.

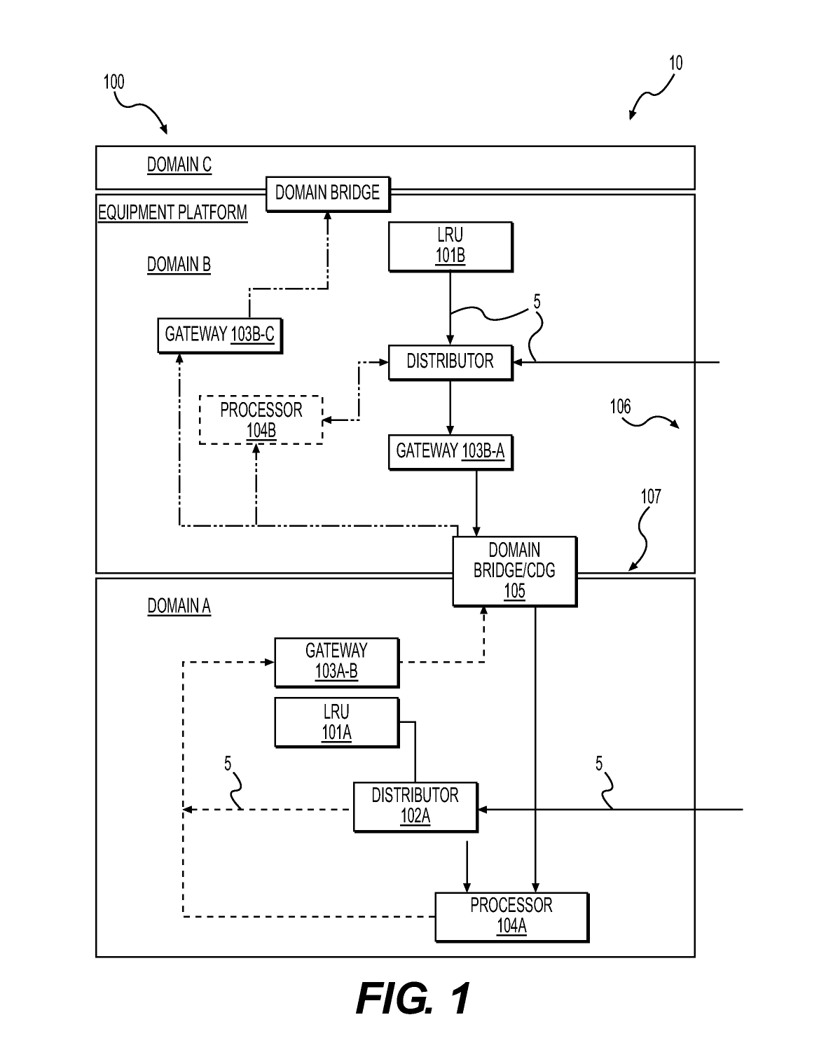

FIG. 1 is a depiction of a simplified equipment platform 100 that is configured in accordance with the subject matter disclosed herein. In this exemplary embodiment there are three domains A, B and C of which only domains A and B are shown in substantial detail. After reading the disclosure herein, one of ordinary skill in the art will recognize that an equipment platform 100 may be segmented into any number of logical and/or physical domains without deviating form the scope of the subject matter being disclosed herein.

Within an equipment platform 100, each domain A-C may have a similar set of operating modules 101-105, where each operating module performs an equivalent function in each of the domains A-C. The operating modules 101-105 may be comprised of hardware, firmware, software or a combination thereof.

Each domain A-C may contain one or more application modules 104 (e.g. a processor) that executes instructions that allow the application module 104 to perform some function. Exemplary functions may include receiving data 5, processing the data, transmitting the processed data to another device, and storing data to a memory location. Non-limiting examples of an application module 104 may include a suitably programmed processor, a co-processor, one or more parallel processors, a programmable logic device (e.g. a field programmable gate array), a digital signal processor (“DSP”) and the like.

According to the subject matter disclosed herein, the application module 104 receives data 5 from a distributor module 102. The distributor module 102 is a computing device that acts as a conduit for the data 5 by becoming a surrogate for the application module 104. Any or all distributor modules 102 within a network 10 may be a surrogate for one or more particular application modules 104 located in the network. A distributor module 102 maybe any suitable computing device that has been configured to advertise on the network 10 as may be known in the art. A non-limiting example of a distributor module 102 may be a properly configured personal computer, a properly configured general purpose computing device, a router, a programmable logic device, a processor, and the like.

The distributor module 102 becomes a surrogate for the application module 104 by advertising itself within the network 10 as being a recipient of, or a depository for, a specific type of data 5 that is generated by a particular Line Replaceable Unit (“LRU”) 101 and that is destined for the application module 104. A LRU 101 is a system component or a sensor of a system component that either generates data or receives a command. Non-limiting examples of an LRU may be a lubrication pump, a vibration sensor monitoring the lubrication pump, a hydraulic actuator, a position indicator on a hydraulic actuator, a computing device and the like. In other words, a LRU 101 may be a system device capable of developing and/or transmitting data 5.

Generally, in any given domain A-C, the data 5 may be received by the application module 104 via one of two routes. In a first route, the data 5 may be received across a domain boundary 107 from an administratively adjacent distributor module 102B within the equipment platform 100. In such instances, the data 5 may traverse both a gateway module 103 and a domain bridge 105.

A gateway module 103 acts as a data collector for data 5 transmitted to and/or from an application module 104. When data 5 arrives at gateway module 103, the data is formatted into a proper datagram syntax with the proper security information to satisfy any security requirements (including the use of data redaction) of the associated domain bridge 105 B/A. The domain bridge 105 B/A then allows the data to pass into the new domain. The domain bridge 105B/A is essentially a fire wall, a cross domain guard (CDG) or other type of security module. The domain bridge 105 may be any type of suitable security module. Non-limiting, exemplary security modules include a firewall, a Demilitarized Zone, a proxy server, a password/sign on combination or nothing at all. A non-limiting example of a Demilitarized Zone known in the art may be found in U.S. Pat. No. 6,490,620 to Ditmer.

Further, one of ordinary skill in the art will recognize after reading the Applicant's disclosure herein that a gateway module 103 and a domain bridge 105 within the same domain or an associated domain may be implemented as standalone modules, may be combined into one or more composite modules or segmented into component modules. For example, a domain (A-C) may have a distributor collector that handles data 5 transmitted from a local distributor module 102 to another domain. Also a domain may have an application module collector that receives data 5 from another domain and forwards that data to its local application module 104.

Therefore, as a simplifying assumption for the sake of brevity herein, the combined function of the gateway modules 103, the domain bridge 105 and any collectors may be viewed as a single device (i.e. a gateway module 103) for relaying data and/or commands to the application module 104 in one direction and republishing or relaying commands and/or data to various distributor modules 102 in other domains in the other direction.

When the application module 104 finishes processing any received data 5, the application module 104 may need to transmit data or commands to remote distributor modules 102 in other domains. To do so, gateways 103B-C and 103A-B may be dedicated gateways disseminating the data and commands from the application module 104 to those remote distributor modules 102.

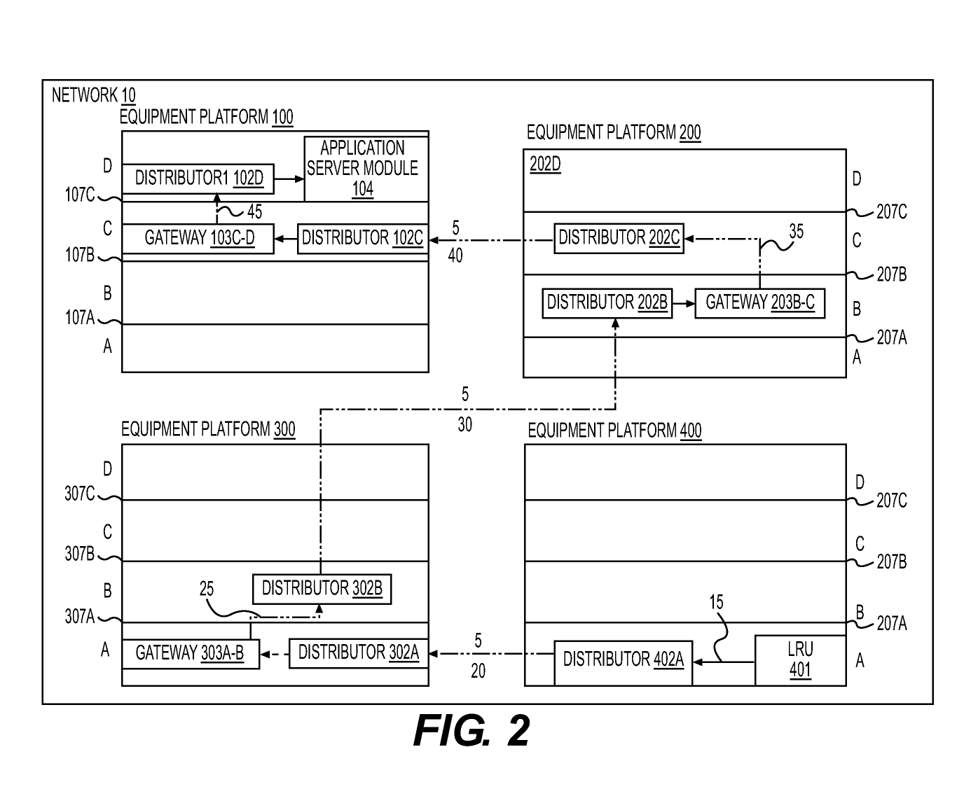

In an exemplary routing, the application module 104A may receive data 5 across a spatial boundary 106 from another equipment platform (e.g. 200) (See, FIG. 2) within the same or an equivalent administrative domain via a local distributor module 102A. Because the data 5 is being transmitted from a domain at the same or equivalent administrative level as that containing the local distributor module 102A, the data 5 may be received directly by the local distributor module without any security measures being imposed because the data 5 has already been vetted when it entered the equivalent domain at the originating equipment platform (e.g. 200-400).

In the exemplary embodiment of FIG. 1, the distributor module 102A acts as a surrogate for its local application module 104A. Similarly, distributor module 102B may also act as a surrogate for application module 104A as will be further disclosed below. As surrogates, the distributor modules 102A and 102B advertise to other distributor modules 102 within domains of equipment platform 100 and to distributor modules within domains of other equipment platforms (e.g. 200-400) across the network 10 that they accept data for application module 104A. As surrogates, any data 5 delivered to the distributor modules 102A or B will be forwarded to the application module 104A which is being represented by the surrogates. Conversely, distributor modules 102A and 102B may also transmit data 5 generated by their respective application modules 104.

In general, the distributor modules 102 may have only limited intelligence about the network 10. The only network information that the distributor modules 102 need to know is what data 5 they are looking/advertising for, and which other surrogate distributor modules 102 lay in an adjacent domain or an adjacent equipment platform (e.g. 200-400) in the same or equivalent domain that are also advertising for data 5.

For example, in the embodiment of FIG. 1, distributor module 102B only needs to know that the application module 104A is in an administrative domain somewhere above it or below it in the equipment platform 100. The distributor module 102B sends the data 5 to the gateway module 103 B-A for domain A, which then forwards the data the application module 104A via domain bridge 105.

In embodiments where a distributor module 102 is part of a chain of surrogate distributors across the network 10 that are all advertising for data 5 from LRU 101, only the location of the next advertising surrogate distributor module 102 in the chain need be known by any particular controlling distributor in the chain. A controlling distributor module is a distributor module 102 that is currently in possession of data 5. At any point in time a distributor module 102 may be a controlling distributor in regard to one datagram and simultaneously be a remote distributor capable of receiving one or more other datagrams. A remote distributor module is a distributor module 102 that is advertising for the data 5 but has not received it.

The next surrogate remote distributor module 102 in the chain will either reside one domain up or one domain down in the same equipment platform 100 or will reside in the same domain in a logically and/or spatially adjacent equipment platform. Once the controlling distributor module 102 passes the data 5 to the next remote distributor module 102, the receiving remote distributor becomes the controlling distributor module and looks to pass the data 5 to the next remote distributor module 102 in the chain from which it has received an advertisement for the data 5.

FIG. 2 depicts an exemplary network 10 comprising four equipment platforms (100-400) incorporating the systems and methods disclosed herein. Each equipment platform includes one or more administrative domains (A-D), and each administrative domain includes at least a distributor module 102, 202, 302, 402 and may feature an application server module 104. The network 10 may be a suitably configured wired network or a wireless network as may be found to be useful by one of ordinary skill in the art. As non-limiting examples of a network, the network may be a Local Area Network (“LAN”), Wide Area Network (“WAN”), a cellular telephone network, a Public Switched Telephone Network, a Virtual Private Network (“VPN”) and the like. Any suitable wireless protocol as is currently known in the art or may be developed in the future may be utilized in a wireless network or intranet. Exemplary, non-limiting examples of a wireless protocol may include the Wireless Application Protocol (WAP), Code Division Multiple Access (CDMA), Group Systems for Mobile Communications (GSM), Bluetooth and Zigbee as well as other protocols in the IEEE 802.11 broadcast standard family.

Although only four equipment platforms (100-400) are depicted in FIG. 2, the subject matter disclosed herein may be utilized within any number of networked equipment platforms. Each of equipment platforms 100-400 is configured to include multiple notional enclaves or, in this embodiment, administrative domains A-D. Such enclaves may be organized according to security classifications (e.g. unclassified, confidential, secret and top secret) or segmented by other administrative or logical partitions (e.g. payroll records, health records, job performance records, sales records). Although, FIG. 2 limits each of equipment platforms 100-400 to four domains (A-D) for the sake of clarity, equipment platforms may have any number of segregated notional or administrative domains.

Among other components, an equipment platform (e.g. 400) may include an LRU 401 that generates the data 5. The data 5 may be any kind of data. Exemplary, non-limiting examples of data may include equipment performance data, environmental data, physiological data or a fusion thereof. Although not shown for the sake of clarity, any number of LRUs 401, electronic components or sensors measuring physical phenomena may reside in an equipment platform (100-400) and generate data 5. For purposes of explanation, equipment platform 400 of FIG. 2 incorporates a single LRU 401 that generates the data 5.

Equipment platform 400 may also include at least a distributor module 402A. The distributor module 402A is a local distributor with respect to the LRU 401 because they reside in the same administrative domain A. The local distributor module 402A may be configured to receive any data within the domain 400A requiring further delivery elsewhere or, alternatively, may receive data 5 destined for the domain 400A that is generated from elsewhere in the network 10.

To communicate with another distributor module 102 (e.g. 302B) across an administrative boundary 307A (e.g. A-B) within an equipment platform 300, the distributor module 302A passes data 5 through a gateway (e.g. 303 A-B) and a domain bridge (e.g. 305A-B) (not depicted in FIG. 2; See, FIG. 1). For the sake of clarity, gateways and domain bridges will be herein after discussed as being combined into a single entity and will be referred to as a gateway.

Preferably, there is at least one distributor (e.g. 402A, 302A, 202B, 102C) located in each administrative domain (100A-D, 200A-D, 300A-D, 400A-D) of every equipment platform 100-400 within the network 10. Moreover, for a controlling distributor (e.g. 402A) to be able to communicate with a remote distributor (e.g. 302A), it is preferable that both the controlling distributor and the remote distributor must exist in matching or equivalent administrative domains (A-D). For example, in some embodiments there may be four domains (unclassified, confidential, secret and top secret) that handle information that is divided into unclassified information, confidential information, secret information and top secret information. Preferably then, only distributors (e.g. 102D) in the top secret domain may communicate with another distributor (e.g. 202D) in the top secret domain. To cross domain boundaries, the data 5 must be passed through a gateway (e.g. 103 C-D). It would be at the gateway 103C-D where any necessary security clearance procedures, redaction or other process required for access between domains would occur. Therefore, once top secret data is move across the secret/top secret domain boundary, then the data may move freely through the network from distributor module 102D to other distributor modules in their respective top secret domains. (100D-400D).

FIG. 2 also illustrates a simplified example of a unified method to automatically transmit the data 5 collected at an LRU (e.g. 401) in one administrative domain (e.g. 400A) to an application module (e.g. 104), or other suitable destination located in another administrative domain (e.g. 100D). For such a transmission, data 5 preferably traverses a number of spatial boundaries between equipment platforms 100 and 400 as well as crossing one or more administrative boundaries from domain A to domain D.

For example, distributor module 402A, which is resident on equipment platform 400, has received data 5 at data transfer 15 from the LRU 401 that is destined for processing by application module 104D. Distributor module 402A has thereby become a controlling distributor for the data 5. The controlling distributor module 402A may not know where the application module 104 is located. However, the controlling distributor module 402A recognizes from an advertisement received from the remote distributor module 302A that the remote distributor module 302A may take delivery of the data 5.

The controlling distributor module 402A cannot look through the domain barrier 307A to detect any advertisement from a distributor (e.g. 302B) in administrative domain B of equipment platform 300 because the non-illustrated domain bridge prevents it. Further, distributor module 402A does not have access to gateway module 303A-B except through distributor module 302A. Because the distributor module 302A is a surrogate for application module 104 and resides in the same administrative domain A, distributor module 402A can transmit the data 5 to distributor module 302A at data transfer 20.

Once in receipt of the data 5, the distributor module 302A becomes a controlling distributor and looks to forward the data 5 to application module 104 or to an advertising remote distributor 102, 202, 302, 402 elsewhere in the network 10. Although distributor module 302A may not know where the application module 104D is, it does know that the application module is located above it in the administrative domain structure. It knows this from an advertisement that itself has received from distributor module 302B located in the administrative domain B. As such, distributor module 302A transmits the data to remote distributor module 302B via gateway module 303A-B which utilizes the appropriate security protocol for equipment platform 300 at data transfer 25.

Upon receiving the data 5, the remote distributor module 302B becomes the controlling distributor and looks for application module 104D or an advertising remote distributor 102 elsewhere in the network 10. Although distributor module 302A may not know where the application module 104D is, it does know that a surrogate exists on equipment platform 200. Distributor module 302B knows this from an advertisement that itself has received from distributor module 202B which is located in the administrative domain B on equipment platform 200. As such, control distributor module 302B transmits the data 5 directly to the remote distributor module 202B at data transfer 30.

Once in receipt of the data 5, the distributor module 202B becomes the controlling distributor. Although distributor module 202B may not know where the application module 104D is, it does know that the application module is located above it in the administrative domain structure. It knows this from an advertisement that itself has received from distributor module 202C located in the administrative domain C. As such, distributor module 202B transmits the data to remote distributor module 202C via gateway module 203B utilizing the appropriate security protocol for equipment platform 200 at data transfer 35.

Upon receiving the data 5 destined for application module 104D, the remote distributor module 202C becomes the controlling distributor and looks for application module 104D or a remote distributor module 102, 202, 302, 402 advertising for the data 5. Although distributor module 202C may not know where the application module 104D is, it does know that a surrogate exists on equipment platform 100. It knows this from an advertisement that itself has received from distributor module 102C located in the administrative domain C on equipment platform 100. Being resident in the same administrative domain C, control distributor module 202C transmits the data 5 to the remote distributor module 102C at data transfer 40.

Once in receipt of the data 5, the distributor module 102C becomes the controlling distributor. Although distributor module 102C may not know where the application module 104D is, it does know that the application module is located above it in the administrative domain D. It knows this from an advertisement that itself has received from distributor module 102D located in the administrative domain D. As such, distributor module 102C transmits the data to remote distributor module 102D via gateway 103C utilizing the appropriate security protocol for equipment platform 100 at data transfer 45.

Upon receiving the data 5 destined for application module 104D, the remote distributor module 102D becomes the controlling distributor and looks for application module 104 or for a remote distributor 102, 202, 302, 402 advertising for data 5. Since the application module 104 is located in the same administrative domain and the same equipment platform, the controlling distributor module 102D has a direct interface with the application module 104D and therefore knows its location and delivers the data 5.

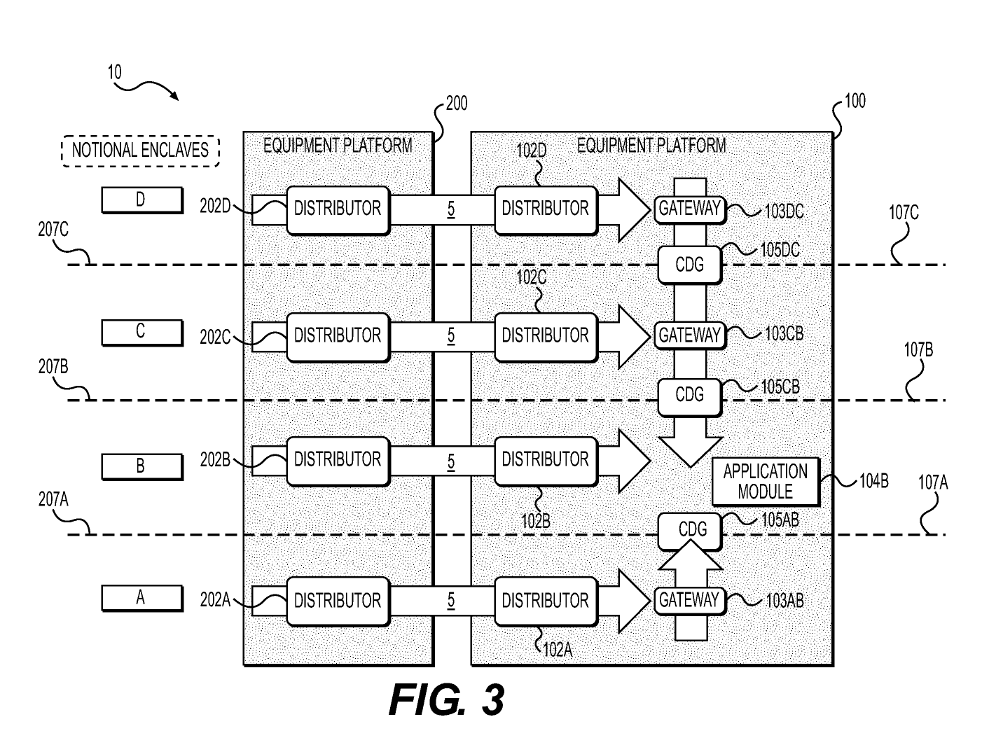

FIG. 3 depicts another exemplary embodiment that highlights the data flow to an application module 104B between equipment platform 200 and equipment platform 100. One of ordinary skill in the art will appreciate after reading subject matter herein, that the combinations and permutation of equipment platforms and domains in the network 10 are manifold. As such, only a simplified example is being depicted herein.

FIG. 3 illustrates an exemplary embodiment demonstrating that the data 5 that may be generated at various places on equipment platform 200 may travel from one or more controlling distributor modules 202A-D to a corresponding remote distributor module 102 A-D across the spatial boundary between the equipment platforms 200 and 100 directly. This is so because each communicating pair of distributor modules 102, 202 exists on the same domain level or an equivalent domain level. Each of the remote distributor modules 102A-D has advertised to other distributor modules in the network 10 that it is receiving data 5 from equipment platform 200. Once received by the remote distributor modules 102D, 102C, and 102A, those distributor modules each become a controlling distributor module and transmit their data 5 in the direction of domain B via their respective gateways (103D-C, 103 C-B, 103A-B) and CDG's (105D-C, 105 C-B, 105A-B). Once in domain 100B, the data 5 is delivered to the application module 104 using methods know to those of ordinary skill in the art. Data 5 received by distributor module 102B is directly sent to the application module 104B because the distributor module 102B has a direct interface with its own local application module 104B.

By utilizing the platform/domain structure described above and configuring the distributor modules 102 within each domain to become surrogates for an application module 104, the application module 104 may be placed in any domain (e.g. D) on any equipment platform (e.g. 100) and be able to receive data 5 from any other domain (A-C) on its local particular equipment platform (100) or from any other remote platform (200-400) in the network 10. Because the network location of the application module 104 may be arbitrary, the subject matter described herein tolerates a dynamic topology that may change from time to time without having to update conventional routing tables. All that is required is that a new processing assignment be implemented, advertised and promulgated.

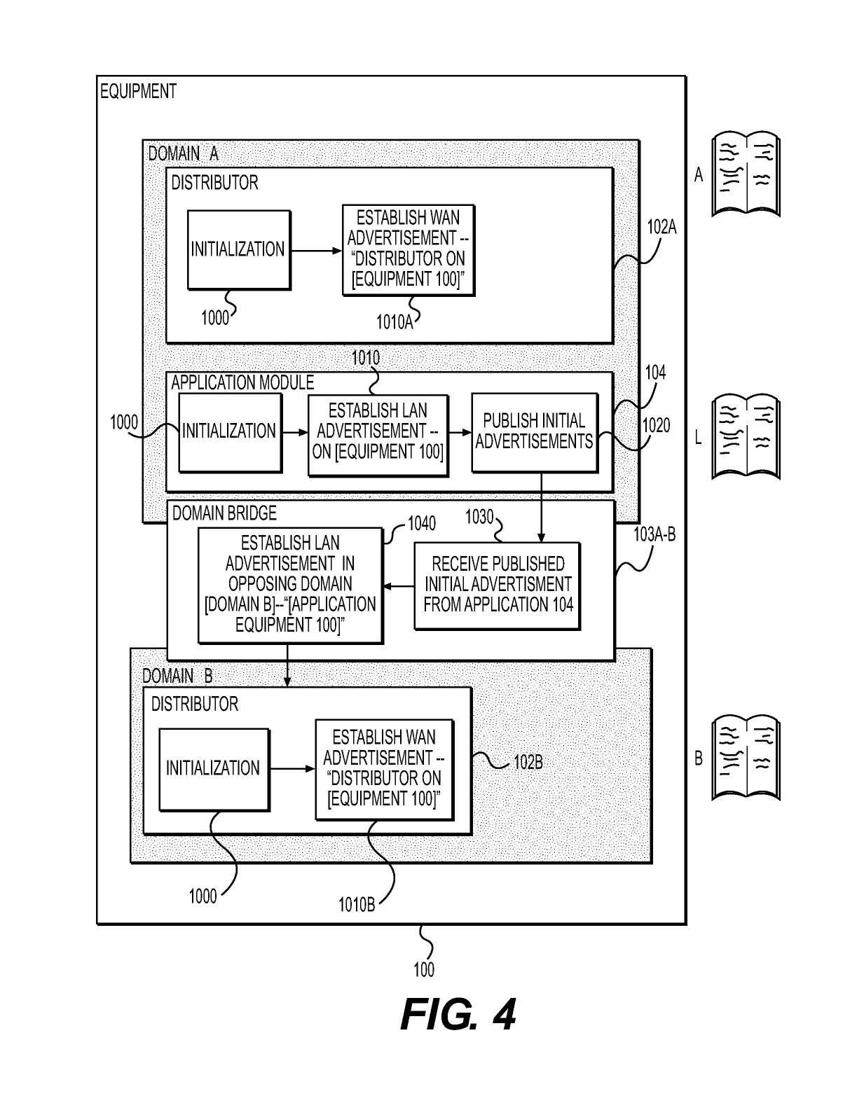

FIG. 4 is a structural flow diagram disclosing an exemplary advertisement process within an equipment platform (e.g. 100). For simplicity the equipment platform has been restricted to only two domains A and B and to only one application module 104 residing in domain A. One of ordinary skill in the art would recognize after reading the disclosure herein that adding additional domains is merely repetitive and that an application module 104 may be located in either domain.

As discussed above, at process 1000, the equipment platform 100 is initialized as may be known in the art. As an example, initialization may be accomplished by applying power to the equipment platform.

At process 1010A, a WAN advertisement is generated by the distributor module 102A announcing that distributor module 102A is a distributor module located on equipment platform 100. The advertisement is essentially a service offering entry made into a domain-wide electronic directory A (also referred to herein as a “WAN directory” for domain A) such that every distributor in domain A references the same directory when handling information for delivery. Similarly, at process 1010B, a WAN advertisement is also generated by the distributor module 102B announcing that distributor module 102B is also distributor located on equipment platform 100. The advertisement is a service offering entry into another domain wide electronic directory B (also referred to herein as a “WAN directory” for domain B) such that every distributor in domain B references the same directory when handling information for delivery. The WAN directory B may be separate from WAN directory A and may have a different set of service entries than WAN directory A.

At process 1010, the application module 104 generates a LAN advertisement which is a service offering that is entered into a directory that is local to the specific equipment platform and to the domain in which the application module 104 is located. The LAN advertisement establishes the presence of an application module 104 on equipment platform 100, domain A. Although the local advertisement is a service entry into an electronic local directory L, this local directory is not referenced by distributors outside the equipment platform 100.

The subject matter being disclosed herein discusses the use of a general advertisement/discovery process. Any suitable discovery process or service known in the art may be utilized. Typically such discovery services may be provided by various operating systems currently in use. Exemplary, non-limiting examples of operating systems that include suitable discovery services include the Macintosh operating system DNS Service using Bonjour®, Sun Java® System Access Manager and Windows XP SSDP Discovery Service with plug and play.

At process 1020, the application module 104 publishes its initial LAN advertisement(s) L for dissemination to all domains throughout the equipment platform 100. For example, at process 1030 the domain bridge/gateway 103A-B receives the published LAN L advertisement from the application module 104 and then establishes the LAN advertisement in domain B that the distributor module 102B in domain B is a surrogate for application module 104 in domain A. In embodiments where there are multiple application modules 104, the LAN directory L would include each advertisement published by each application module.

At the end of the initialization processes depicted in FIG. 4, advertisements establishing the existence of “distributor module on equipment platform 100” are created in WAN directories A and B for each of the domains on the equipment platform 100 as well as creating entries in the LAN directory of equipment platform 100 as to where the application module 104 is located on the equipment platform 100. One of ordinary skill in the art will recognize after reading the Applicant's specification that the WAN advertisements established in each administrative domain may then be propagated throughout the network 10, to other distributor modules 102. Each distributor module 102 then becomes a surrogate for application module 104 by advertising that it can accept data 5.

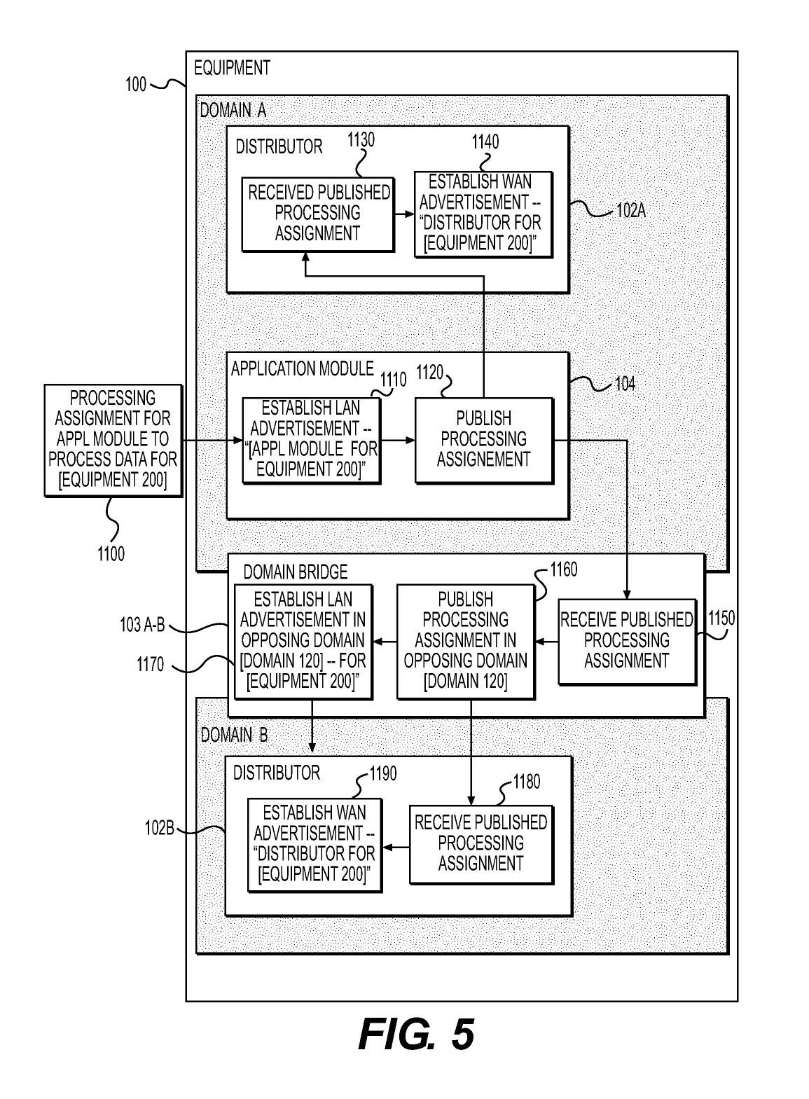

FIG. 5 is a structural flow diagram disclosing an exemplary method for creating a processing responsibility within an equipment platform (e.g. 100). At process 1100, a processing assignment is received from a network management system (not shown) assigning application module 104 of equipment platform 100 to process data 5 for equipment platform 200. At process 1110, the application module 104 again establishes a LAN advertisement in its LAN directory L that application module 104 processes data for equipment platform 200.

At process 1120, the LAN advertisement is again published to all domains (A-D) in the equipment platform 100. At process 1130, the distributor module 102A receives the processing assignment and, at process 1140, establishes a WAN advertisement in its WAN directory A that it will accept data 5 from equipment platform 200.

Similarly, at process 1150, the domain bridge 103A-B receives the processing assignment and publishes the processing assignment to domain B where distributor module 102B receives the assignment at process 1180. At process 1190, distributor module 102B establishes a WAN advertisement in its WAN directory B that will accept data 5 from equipment platform 200. At process 1170, the domain bridge 103A-B establishes a LAN advertisement in the LAN directory L that application module 104 processes data for equipment platform 200.

The method depicted in FIG. 5 establishes that an application module 104 on equipment platform 100 (e.g. a command and control vehicle) will process data from a second equipment platform (e.g. an Abrams main battle tank). The method also places advertisements on the various WAN directories A and the WAN directories B that the respective distributors in all of the different domains of the command and control vehicle (i.e. 102A and 102 B) which act as surrogates of the application module 104 by accepting data 5 sent by the Abrams main battle tank and forwarding the data 5 to the application module 104.

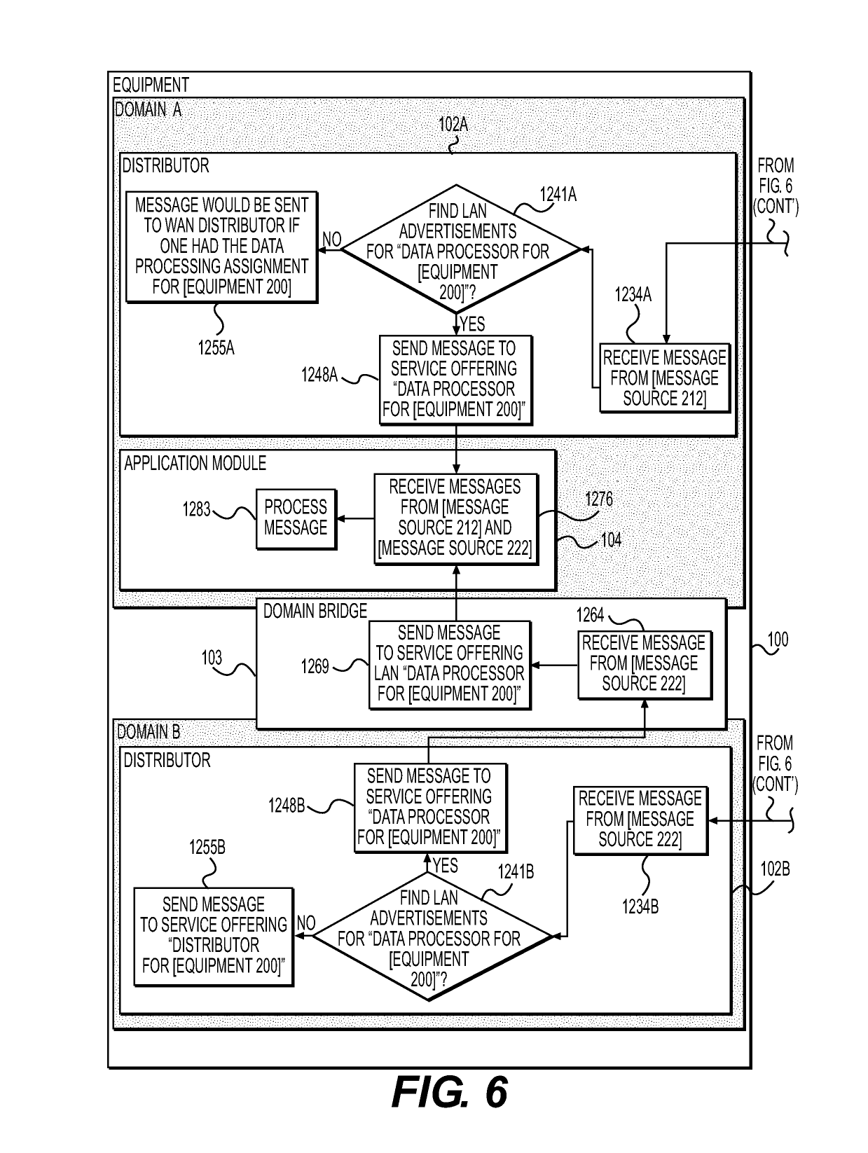

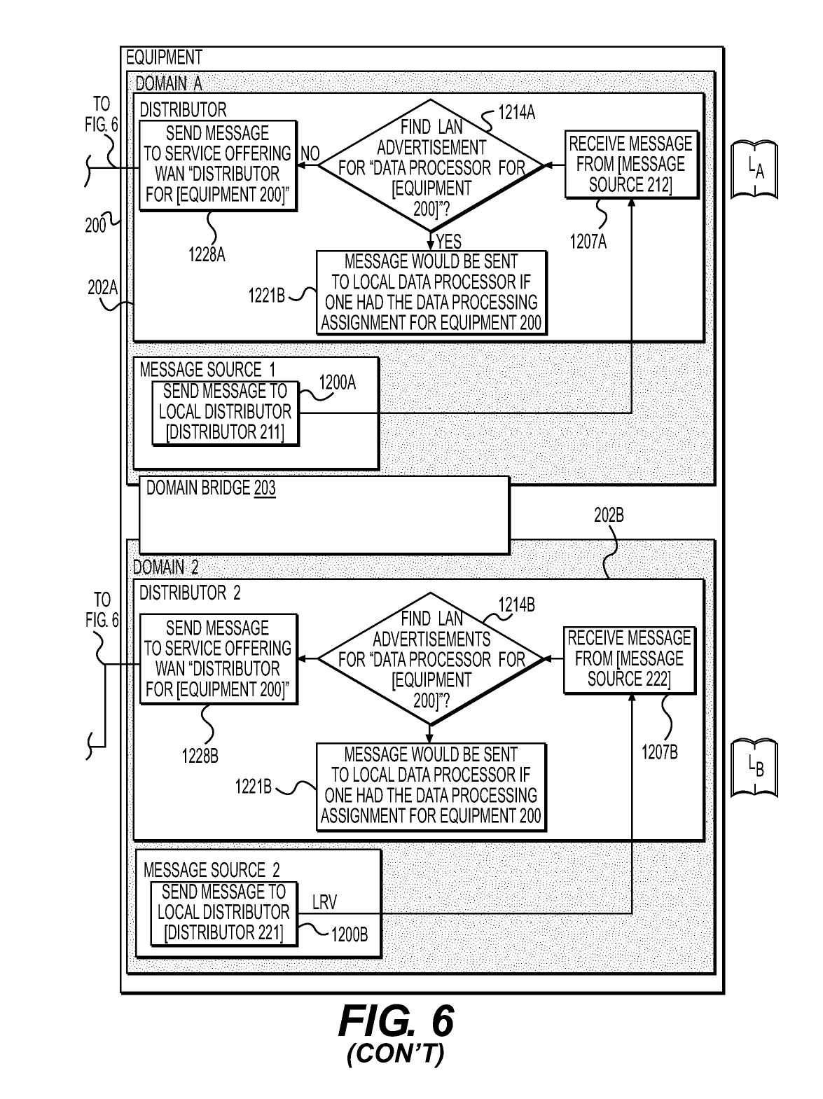

FIG. 6 is a structural flow diagram illustrating an exemplary method for transmitting data 5 across the network 10 utilizing the subject matter disclosed herein. In this example, the equipment platform 200 (i.e. the Abrams tank) has data 5 waiting at message source 1 and at message source 2 to be processed by application module 104. Message source 1 and 2 do not know where the appropriate application module 104 for the data 5 is located. Therefore, during processes 1200A and 1200B, the message sources 1 and 2, respectively, send their data to their respective local distributor modules 202A or 202B. The message sources 1 and 2 know to do this because each message source 1 and 2 have been programmed to know what local advertisement to look for in the LAN directories L governing their respective domains. For example, the message source 1(2) may look for the LAN advertisement “Distributor in domain A(B) on equipment platform 200.” At processes 1200A/B, the message sources send their data 5 to their respective local distributor modules 202A and 202B.

At process 1207A/B, distributor modules 202A/B receive the data 5. At processes 1214A and 1214B, the distributor modules 202A and 202B, respectively, consult their respective local LAN directories L_{A} or L_{B}. The distributor modules 202A and 202B know the source of the data 5 from information in the datagram received. They may also know that they must get the data 5 to an application module somewhere. Therefore, the distributor modules 202A and 202B look for a LAN advertisement for an application module 104 located in their own equipment platform 200. If an application module 104 is found in the LAN directories L_{A} or L_{B}, then the data 5 would be sent to the local application module 104 if that local application module had the data processing assignment for equipment platform 200 (See processes 1221A/B). Since there are no local application modules 104 assigned to receive data 5 in this exemplary embodiment, the controlling distributor modules 202A and 202B consult the WAN directories for domains A an B, respectively, and then send their data to the remote distributor modules 102A and 102B that are advertising in this directory to be a remote distributor 102 for data 5 from equipment platform 200, at processes 1228A/B.

At processes 1234A/B, the data 5 is received by remote distributor modules 102A/B. Because the administrative domains of both the controlling and the remote distributors are the same, the data 5 may be passed directly between equipment platforms with out security procedures.

At process 1241A/B the distributor modules 102A and 102B each consult their LAN directory L for “an application module receiving data from the equipment platform 200.” If the advertisement for application module 104 is not found then the controlling distributor module 102A or 102B acts as a surrogate for the application module 104, receiving data from the equipment platform 200 located on the network. The data 5 would then be sent to a remote distributor elsewhere in the network 10 after consulting with the WAN directories A/B of equipment platform 200.

Because in this example the LAN advertisements for the data 5 would be found in the local LAN directories L_{A} and L_{B}, the controlling distributor modules 102A/B send the data 5 towards the application module 104. In the case of distributor module 102A, the application module 104 is located in the same domain as the distributor 102A. Because the distributor modules 102 in a particular domain have an interface with the application module n their domain, the data 5 is received by the application module 104 directly from the distributor module 102A at process 1276 where it is processed by the application module.

In the case of distributor module 102B, there happens to be no application module located in domain B that has been assigned to receive and process data 5. Therefore, the data 5 must be processed through the gateway or domain bridge 103A-B in a tightly formatted message or other suitable security protocol that may be known in the art. At process 1262, the data 5 is received by the domain bridge 103A-B. At process 1269, the domain bridge 103A-B examines the tightly formatted data message created by the distributor module 102B and if the data 5 is allowed to pass, the domain bridge 103A-B sends the data to the application module 104, at process 1262, where it is processed by the application module 104 at process 1283.

The subject matter described above is provided by way of illustration only and should not be construed as being limiting. Various modifications and changes may be made to the subject matter described herein without following the example embodiments and applications illustrated and described, and without departing from the true spirit and scope of the present invention, which is set forth in the following claims.

What is claimed is:

1. A system for distributing a data message from an originating device to an unknown destination device across at least one spatial boundary and at least one administrative domain boundary in a network that includes a plurality of equipment platforms, each equipment platform including at least one administrative domain, comprising:
a plurality of distributor modules, each distributor module resident within one of the administrative domains and configured to (i) publish an advertisement for one or more data messages, (ii) receive data messages for which it has published the advertisement, (iii) and selectively transmit the received data messages either across the at least one spatial boundary to another one of the plurality of distributor modules or within the administrative boundary that it resides; and
a plurality of domain bridges, each domain bridge spanning the at least one administrative domain boundary within each equipment platform, each domain bridge configured to (i) forward the advertisement for one or more data messages, (ii) receive data messages transmitted from one or more distributor modules in the same equipment platform and for which it has forwarded the advertisement, and (iii) transmit the received data messages across the administrative domain boundary that it spans to another one of the plurality of distributor modules in the same equipment platform; and
a means for discovering the advertisement for the one or more data messages that is published by the one or more distributor modules, the one or more distributor modules being one of spatially and administratively distant from the administrative domain in which the one or more data message exists.

2. The system of claim 1, wherein a first distributor module of the plurality of distributor modules only communicates directly with a second distributor module of the plurality when the first distributor module of the plurality exists in an administrative domain that is equivalent to the administrative domain of the second distributor of the plurality.

3. The system of claim 2, wherein each of the distributor modules of the plurality of distributor modules is one of a controlling distributor module and a remote distributor module.

4. The system of claim 3, wherein the distributor module in which the data message exists is the controlling distributor.

5. The system of claim 3, wherein the distributor module that is one of spatially and administratively distant from the distributor module in which the data message exists is the remote distributor module.

6. The system of claim 2, wherein each distributor module of the plurality includes a local area network directory.

7. The system of claim 6, wherein each distributor module of the plurality includes a wide area network directory.

8. The system of claim 7, wherein the controlling distributor examines its local area network directory to ascertain a computing device that is advertising for the data message from the originating device.

9. The system of claim 8, wherein the controlling distributor examines its wide area network directory to ascertain a remote distributor that is advertising for the data message from the originating device.

10. The system of claim 9, wherein the controlling distributor sends the data message to the remote distributor that is advertising for the data message from the originating device based at least in part on which of the local area network directory and the wide area network directory the advertisement for the data message from the originating device is found.

11. The system of claim 10, wherein the local area network directory is examined before the wide area network directory.

12. A method for distributing a data message from an originating computing device to an unknown destination device across at least one spatial boundary and at least one administrative domain boundary, comprising:
receiving a data message from the originating computing device;
discovering an advertisement published in a local area network (LAN) directory advertising that a device is a local processor for the data message;
if a LAN advertisement is found in the LAN directory, then delivering the data message to the local processor;
if an LAN advertisement is not found in the LAN directory, then discovering an advertisement published in a wide area network directory advertising that a remote device is a surrogate distributor module for the data message from the originating computing device; and
delivering the message to the advertising surrogate distributor module.

13. The method of claim 10, wherein the remote device is located across a spatial boundary.

14. The method of claim 11, wherein the remote device is located across an administrative boundary.

15. The method of claim 10, wherein the spatial boundary is separating a first administrative domain and a second administrative domain.

16. The method of claim 15, wherein the data message is transmitted from the first administrative domain to the second administrative domain without executing an intervening information security protocol when the first administrative domain and the second administrative domain are at least equivalent domains.

17. The method of claim 13, wherein the remote device becomes a controlling device upon receiving the data message.

18. The method of claim 15, wherein the data message is transmitted from the first administrative domain to the second administrative domain after executing an intervening information security protocol when the first administrative domain and the second administrative domain are not equivalent domains

19. A computer readable storage medium containing instructions that when executed perform functions, comprising:
receive a data message from the originating computing device;
discover an advertisement published in a local area network (LAN) directory advertising that a device is a local processor for the data message from the originating computing device;
if the advertisement published in the LAN directory is found, then deliver the data message to the local processor;
if the advertisement published in a LAN directory is not found, then discover an advertisement published in a wide area network (WAN) directory advertising that a remote device is a surrogate distributor module for the data message from the originating computing device; and
deliver the message to the advertising distributor module.

20. The computer readable storage medium of claim 19 where in the data is received across both of a spatial boundary and an administrative boundary.
